(19) United States
(12) Patent Application Publication
(10) Pub. No.: US 2025/0113753 A1
(43) Pub. Date: Apr. 10, 2025

(54) CONTROL SYSTEM FOR AN AGRICULTURAL TILLAGE IMPLEMENT

(71) Applicant: CNH Industrial America LLC, New Holland, PA (US)

(72) Inventors: Michael W. Glennon, Normal, IL (US); Derek Sicheneder, Morton, IL (US); Heath A. Toennies, Eureka, IL (US)

(21) Appl. No.: 18/906,671

(22) Filed: Oct. 4, 2024

Related U.S. Application Data
(60) Provisional application No. 63/588,469, filed on Oct. 6, 2023.

(51) Int. Cl. A01B 63/22; A01B 49/02

(52) U.S. Cl. CPC A01B 63/22; A01B 49/027

(57) ABSTRACT

A control system for an agricultural tillage implement includes a controller configured to receive a pressure sensor signal indicative of a fluid pressure within a rolling basket cylinder and/or an angle sensor signal indicative of an angle of a rolling basket frame relative to a main frame. The rolling basket cylinder is configured to couple to the main frame and to the rolling basket frame. The controller is also configured to control a tilt force applied by a tilt actuator to the main frame to maintain the fluid pressure within a threshold fluid pressure range of a target fluid pressure and/or to maintain the angle of the rolling basket frame within a threshold angle range of a target angle. The tilt actuator is configured to couple to a hitch assembly and to apply the tilt force to the main frame.

### BACKGROUND

The present disclosure relates to a control system for an agricultural tillage implement.

Certain agricultural implements include ground engaging tools configured to interact with soil. For example, a tillage implement may include disc blades configured to break up a top layer of the soil for subsequent planting or seeding operations. The disc blades may be arranged in a front row and a rear row. As the tillage implement traverses a field, the forces acting to drive the disc blades into the soil may become unbalanced, thereby resulting in variations in the penetration depth of the disc blades (e.g., at least the disc blades of the rear row). Accordingly, the disc blades may break up the top layer of the soil at varying depths, which may reduce the effectiveness of the tillage operation.

### BRIEF DESCRIPTION

In certain embodiments, a control system for an agricultural tillage implement includes a controller having a memory and a processor. The controller is configured to receive a pressure sensor signal indicative of a fluid pressure within a rolling basket cylinder and/or an angle sensor signal indicative of an angle of a rolling basket frame relative to a main frame of the agricultural tillage implement. The rolling basket cylinder is configured to couple to the main frame and to the rolling basket frame. The controller is also configured to control a tilt force applied by a tilt actuator to the main frame to maintain the fluid pressure within a threshold fluid pressure range of a target fluid pressure and/or to maintain the angle of the rolling basket frame within a threshold angle range of a target angle. The tilt actuator is configured to couple to a hitch assembly of the agricultural tillage implement and to apply the tilt force to the main frame.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a perspective view of an embodiment of a tillage implement having a control system;

FIG. 2 is a perspective view of a portion of the tillage implement of FIG. 1;

FIG. 3 is a schematic view of an embodiment of a control system that may be employed within the tillage implement of FIG. 1; and

FIG. 4 is a flow diagram of an embodiment of a method for controlling a tilt actuator of a tillage implement.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

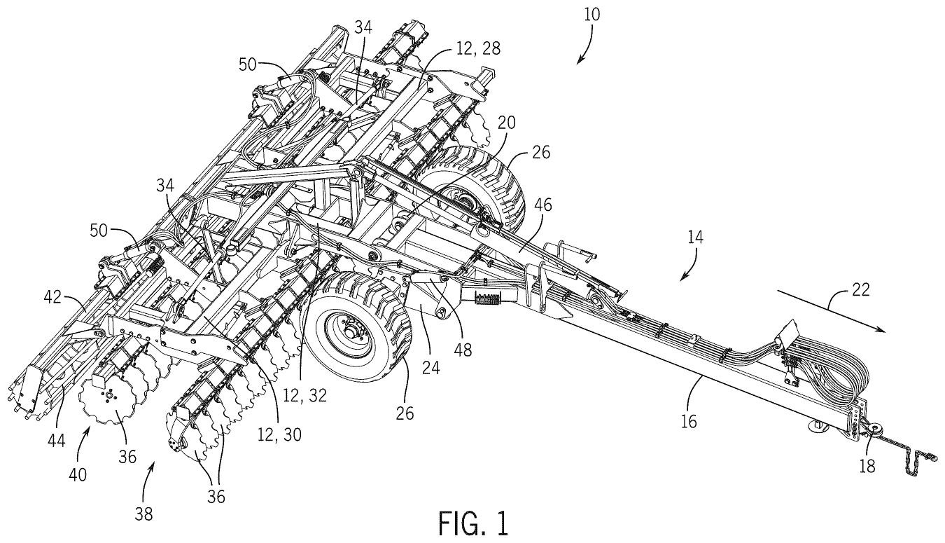

FIG. 1 is a perspective view of an embodiment of a tillage implement 10 (e.g., agricultural tillage implement) having a control system. In the illustrated embodiment, the tillage implement 10 is a high speed compact tillage implement having multiple ground engaging tools configured to till soil. As illustrated, the tillage implement 10 includes a main frame 12 and a hitch assembly 14 pivotally coupled to the main frame 12. In the illustrated embodiment, the hitch assembly 14 includes a hitch frame 16 and a hitch 18. The hitch frame 16 is pivotally coupled to the main frame 12 via pivot joint(s) 20, and the hitch 18 is configured to couple to a corresponding hitch of a work vehicle (e.g., tractor), which is configured to tow the tillage implement 10 through a field along a direction of travel 22.

Furthermore, the tillage implement 10 includes a wheel frame 24 pivotally coupled to the hitch frame 16 of the hitch assembly 14. In the illustrated embodiment, the tillage implement 10 includes two wheels 26 rotatably coupled to the wheel frame 24. The wheels 26 are configured to engage a surface of the field and to support a portion of the weight of the tillage implement 10 as the tillage implement 10 is towed through the field along the direction of travel 22. While the tillage implement 10 includes two wheels 26 in the illustrated embodiment, in other embodiments, the tillage implement may include more or fewer wheels rotatably coupled to the wheel frame (e.g., 1, 3, 4, 5, 6, or more). Furthermore, in certain embodiments, the tillage implement may include one or more tracks (e.g., alone or in combination with one or more wheels). While the wheel frame is coupled to the hitch frame by a pivotal connection in the illustrated embodiment, in other embodiments, the wheel frame may be movably coupled to the hitch frame by another suitable connection (e.g., sliding connection, linkage assembly, etc.) that facilitates adjustment of a vertical position of the wheels relative to the hitch frame.

In the illustrated embodiment, the main frame 12 includes a left wing section 28 and a right wing section 30. Each wing section is pivotally coupled to a center section 32 of the main frame 12. Furthermore, the tillage implement 10 includes wing actuators 34 configured to urge each wing section downwardly relative to the center section 32. Each wing actuator 34 is coupled to the center section 32 and to a respective wing section. While the main frame 12 includes the center section 32, the left wing section 28, and the right wing section 30 in the illustrated embodiment, in other embodiments, the main frame may include more or fewer sections. For example, in certain embodiments, the main frame may be substantially rigid (e.g., not including any wing sections). In such embodiments, the wing actuators may be omitted. Furthermore, the main frame 12 may be formed from multiple frame elements (e.g., rails, tubes, braces, etc.) coupled to one another (e.g., via welded connection(s), via fastener connection(s), etc.).

In the illustrated embodiment, the tillage implement 10 includes disc blades 36 configured to engage a top layer of the soil. As the tillage implement 10 is towed through the field along the direction of travel 22, the disc blades 36 are driven to rotate, thereby breaking up the top layer of the soil. In the illustrated embodiment, the disc blades 36 are arranged in a front row 38 and a rear row 40. However, in other embodiments, the disc blades may be arranged in more or fewer rows (e.g., 1, 3, 4, 5, 6, or more). Furthermore, in the illustrated embodiment, each disc blade 36 is independently mounted to the main frame 12. Accordingly, each disc blade 36 may rotate independently of the other disc blades 36. While each disc blade 36 is independently mounted to the main frame 12 in the illustrated embodiment, in other embodiments, at least a portion of the disc blades may be mounted to the main frame in one or more gangs, in which the disc blades of each gang are configured to rotate together as the tillage implement is towed through the field.

Furthermore, in the illustrated embodiment, the tillage implement 10 includes a rolling basket frame 42 (e.g., gauge device frame) pivotally coupled to the main frame 12. The tillage implement 10 also includes a rolling basket 44 rotatably coupled to the rolling basket frame 42. As the tillage implement 10 is towed through the field along the direction of travel 22, the rolling basket 44 is driven to rotate, thereby sizing soil clods, leveling the soil surface, smoothing the soil surface, or a combination thereof. In the illustrated embodiment, the rolling basket frame 42 includes a left section pivotally coupled to the left wing section 28 of the main frame 12, and the rolling basket frame 42 includes a right section pivotally coupled to the right wing section 30 of the main frame 12. In addition, the rolling basket 44 includes a left section rotatably coupled to the left section of the rolling basket frame 42, and the rolling basket 44 includes a right section rotatably coupled to the right section of the rolling basket frame 42. In certain embodiments (e.g., in embodiments in which the main frame is substantially rigid), the rolling basket frame may have a single section, and/or the rolling basket may have a single section. In addition, in certain embodiments (e.g., in embodiments in which the main frame includes more than two sections), each rolling basket frame section may be pivotally coupled to a respective main frame section, and each rolling basket section may be rotatably coupled to a respective rolling basket section.

While the tillage implement includes the disc blades 36 and a rolling basket 44 in the illustrated embodiment, in other embodiments, the tillage implement may include other/additional ground engaging tool(s). For example, in certain embodiments, the tillage implement may include tillage point assemblies (e.g., positioned behind the disc blades and in front of the rolling basket relative to the direction of travel) configured to engage the soil at a greater depth than the disc blades, thereby breaking up a lower layer of the soil. Each tillage point assembly may include a tillage point and a shank. The shank may position the tillage point at a target depth beneath the soil surface, and the tillage point may break up the soil. The shape of each tillage point, the arrangement of the tillage point assemblies, and the number of tillage point assemblies may be selected to control tillage within the field. Furthermore, in certain embodiments, the tillage implement may include finishing discs (e.g., positioned behind the disc blades and in front of the rolling basket relative to the direction of travel). In such embodiments, as the tillage implement is towed through the field, the finishing discs may be driven to rotate, thereby sizing soil clods, leveling the soil surface, smoothing the soil surface, cutting residue on the soil surface, or a combination thereof. In addition, in certain embodiments, the tillage implement may include one or more other/additional suitable ground engaging tools, such as coulter(s), opener(s), tine(s), other suitable ground engaging tool(s), or a combination thereof. Furthermore, while the tillage implement 10 is a high speed compact tillage implement in the illustrated embodiment, in other embodiments, the tillage implement may be a primary tillage implement, a vertical tillage implement, or another suitable type of tillage implement.

In the illustrated embodiment, the tillage implement 10 includes a tilt actuator 46 (e.g., frame force actuator) coupled to the hitch frame 16 of the hitch assembly 14 and to the main frame 12. The tilt actuator 46 is configured to apply a tilt force (e.g., frame force) to the main frame 12, thereby urging the main frame 12 toward the surface of the field. Accordingly, the disc blades 36 and the rolling basket 44 may be driven into the soil. The tilt actuator 46 may include any suitable type of actuator, such as a hydraulic cylinder, a pneumatic cylinder, an electric linear actuator, a hydraulic motor, a pneumatic motor, an electric motor, etc. Furthermore, while the tillage implement 10 includes a single tilt actuator 46 in the illustrated embodiment, in other embodiments, the tillage implement may include additional tilt actuator(s) (e.g., 1, 2, 3, 4, or more additional tilt actuator(s)).

Furthermore, in the illustrated embodiment, the tillage implement 10 includes one or more wheel frame actuators 48, in which each wheel frame actuator 48 is coupled to the wheel frame 24 and to the hitch frame 16 of the hitch assembly 14. Each wheel frame actuator 48 is configured to control the position of the wheels 26 relative to the hitch frame 16, thereby controlling the position of the pivot joint(s) 20 relative to the surface of the field. As a result, the wheel frame actuators 48 are configured to control the height of the main frame 12 (e.g., at least a front portion of the main frame 12) relative to the surface of the field, thereby controlling the penetration depth of the disc blades 36 (e.g., at least the front row 38 of disc blades 36) into the soil. Each wheel frame actuator 48 may include any suitable type of actuator, such as a hydraulic cylinder, a pneumatic cylinder, an electric linear actuator, a hydraulic motor, a pneumatic motor, an electric motor, etc. Furthermore, while the tillage implement 10 includes two wheel frame actuators 48 in the illustrated embodiment, in other embodiments, the tillage implement may include more or fewer wheel frame actuators (e.g., 1, 3, 4, 5, 6, or more).

In addition, in the illustrated embodiment, the tillage implement 10 includes one or more rolling basket cylinders 50 (e.g., gauge device cylinders), in which each rolling basket cylinder 50 is coupled to the main frame 12 and to the rolling basket frame 42. Each rolling basket cylinder 50 may include any suitable type of cylinder, such as a hydraulic cylinder or a pneumatic cylinder. Furthermore, in the illustrated embodiment, the tillage implement 10 includes one rolling basket cylinder 50 for each section of the rolling basket frame 42. However, in other embodiments, the tillage implement may include multiple rolling basket cylinders for at least one rolling basket frame section (e.g., 2, 3, 4, or more). Furthermore, in embodiments in which the rolling basket frame has a single section, the tillage implement may include any suitable number of rolling basket cylinders for the single section (e.g., 1, 2, 3, 4, or more). The penetration depth of the disc blades 36 may be adjusted by controlling the extension of the wheel frame actuator(s) 48 and the extension of the rolling basket cylinder(s) 50.

As discussed in detail below, the tillage implement 10 includes a control system having a controller. The controller includes a memory and a processor, and the controller is communicatively coupled to the tilt actuator 46. The controller is configured to receive a pressure sensor signal indicative of a fluid pressure within the rolling basket cylinder(s) 50 and/or an angle sensor signal indicative of an angle of the rolling basket frame 42 relative to the main frame 12. Furthermore, the controller is configured to control the tilt force applied by the tilt actuator 46 to the main frame 12 to maintain the fluid pressure within a threshold fluid pressure range of a target fluid pressure and/or to maintain the angle of the rolling basket frame 42 within a threshold angle range of a target angle. Maintaining the fluid pressure within the threshold fluid pressure range of the target fluid pressure and/or maintaining the angle of the rolling basket frame 42 within the threshold angle range of the target angle may substantially maintain the penetration depth of the disc blades 36 (e.g., at least the rear row 40 of disc blades 36) as the tillage implement 10 is towed along the field in the direction of travel 22 (e.g., as the tillage implement 10 encounters bumpy terrain). As a result, the disc blades 36 of the tillage implement 10 may break up the top layer of the soil at a consistent depth, thereby enhancing the effectiveness of tillage operations. For example, while the tillage implement 10 is operating within a region of denser soil, the controller may control the tilt actuator 46 to increase the tilt force applied to the main frame 12 to maintain the fluid pressure within the threshold fluid pressure range of the target fluid pressure and/or to maintain the angle of the rolling basket frame 42 within the threshold angle range of the target angle, thereby increasing the longitudinal rigidity of the tillage implement 10. In addition, while the tillage implement 10 is operating within a region of less dense soil, the controller may control the tilt actuator 46 to decrease the tilt force applied to the main frame 12 to maintain the fluid pressure within the threshold fluid pressure range of the target fluid pressure and/or to maintain the angle of the rolling basket frame 42 within the threshold angle range of the target angle, thereby reducing the longitudinal rigidity of the tillage implement 10.

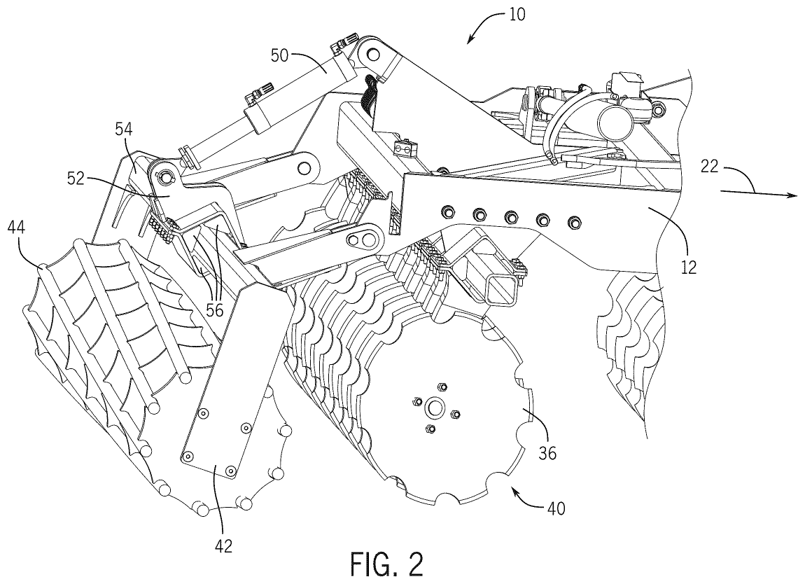

FIG. 2 is a perspective view of a portion of the tillage implement 10 of FIG. 1. As previously discussed, the rolling basket frame 42 is pivotally coupled to the main frame 12, and the rolling basket 44 is rotatably coupled to the rolling basket frame 42. As the tillage implement 10 is towed through the field along the direction of travel 22, the rolling basket 44 is driven to rotate, thereby sizing soil clods, leveling the soil surface, smoothing the soil surface, or a combination thereof. Furthermore, the rolling basket cylinder(s) 50 are coupled to the main frame 12 and to the rolling basket frame 42.

In the illustrated embodiment, each rolling basket cylinder 50 is pivotally coupled to a respective mount 52, and each mount 52 is disposed about a frame member 54 (e.g., a respective frame member, a common frame member, etc.) of the rolling basket frame 42. Furthermore, in the illustrated embodiment, resilient elements 56 are disposed between the mount 52 and the frame member 54 of the rolling basket frame 42. Accordingly, the rolling basket cylinder 50 is coupled to the rolling basket frame 42 via the mount 52 and the resilient elements 56. The resilient elements 56 are configured to enable the rolling basket frame 42 to rotate relative to the mount 52 and to urge the rolling basket frame 42 to rotate toward the illustrated undeflected position, which corresponds to an undeflected angle of the rolling basket frame 42 relative to the mount 52. During operation of the tillage implement 10, the rolling basket 44 is engaged with the soil, which may drive the rolling basket frame 42 to rotate relative to the mount 52 against the torque applied by the resilient elements 56. Accordingly, the resilient elements 56 may apply a torque to the rolling basket frame 42 while the rolling basket 44 is engaged with the soil. The downforce applied by the rolling basket 44 to the soil is based on the torque applied by the resilient elements 56 to the rolling basket frame 42, and the torque applied by the resilient elements 56 to the rolling basket frame 42 is based on the angular offset of the rolling basket frame 42 with respect to the illustrated undeflected position. Furthermore, the angular offset of the rolling basket frame 42 with respect to the undeflected position (e.g., with respect to the undeflected angle of the rolling basket frame 42 relative to the mount 52) is based on the angle of the rolling basket frame 42 relative to the main frame 12 and the extension of the rolling basket cylinder 50. The extension of the rolling basket cylinder 50 is adjustable, but may remain fixed/constant as the angular offset of the rolling basket frame 42 varies.

In the illustrated embodiment, four resilient elements 56 are disposed between the mount 52 and the frame member 54 of the rolling basket frame 42. However, in other embodiments, more or fewer resilient elements may be disposed between the mount and the frame member of the rolling basket frame (e.g., 1, 2, 3, 5, 6, or more). Furthermore, while resilient elements are configured to enable the rolling basket frame 42 to rotate relative to the mount 52 and to urge the rolling basket frame 42 to rotate toward the undeflected position in the illustrated embodiment, in other embodiments, other suitable element(s)/device(s) may be used to enable rotation of the rolling basket frame relative to the mount and to urge the rolling basket frame to rotate toward the undeflected position. For example, in certain embodiments, the rolling basket frame may be pivotally coupled to the mount, and a biasing element, such as a spring (e.g., coil spring, leaf spring, etc.), a pneumatic cylinder, etc., may urge the rolling basket frame to rotate toward the undeflected position. In addition, in embodiments in which the tillage implement includes multiple rolling basket cylinders for the rolling basket frame section, each rolling basket cylinder may be pivotally coupled to a respective mount (e.g., disposed about the frame member). Furthermore, in certain embodiments, the rolling basket cylinder (e.g., each rolling basket cylinder) may be directly pivotally coupled to the rolling basket frame (e.g., the tillage implement may not include any element(s)/device(s) configured to urge the rolling basket frame to rotate relative to the rolling basket cylinder(s)). While one section of the rolling basket frame 42 and one section of the rolling basket 44 are shown in FIG. 2 and discussed above, the structures and variations disclosed above may be applied to the other section(s) of the rolling basket frame/rolling basket. For example, in certain embodiments, a mount may be disposed about a frame member of another section of the rolling basket frame, a rolling basket cylinder may be pivotally coupled to the mount, and resilient elements may be disposed between the mount and the frame member.

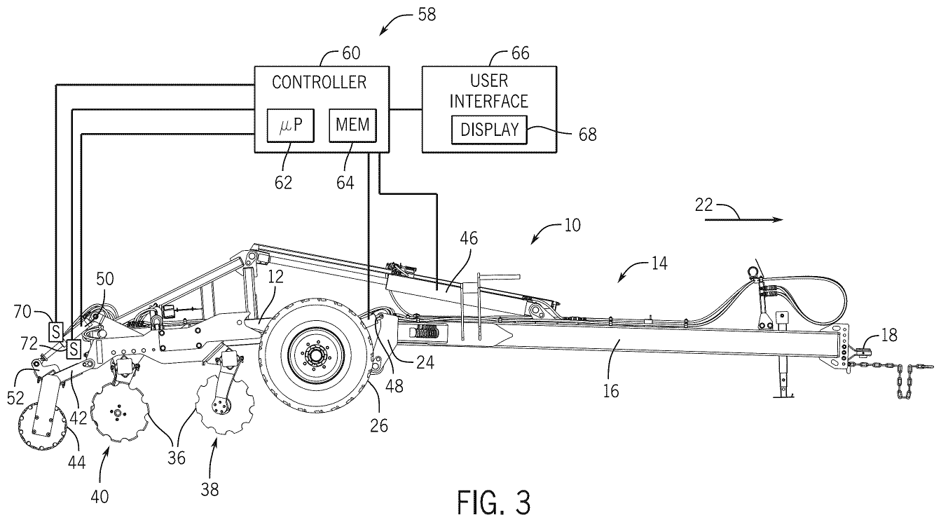

FIG. 3 is a schematic view of an embodiment of a control system 58 that may be employed within the tillage implement 10 of FIG. 1. In the illustrated embodiment, the control system 58 includes a controller 60 communicatively coupled to the tilt actuator 46, to the wheel frame actuator(s) 48, and to the rolling basket cylinder(s) 50. In certain embodiments, the controller 60 is an electronic controller having electrical circuitry configured to control the tilt actuator 46, the wheel frame actuator(s) 48, and the rolling basket cylinder(s) 50. In the illustrated embodiment, the controller 60 includes a processor, such as the illustrated microprocessor 62, and a memory device 64. The controller 60 may also include one or more storage devices and/or other suitable components. The processor 62 may be used to execute software, such as software for controlling the tilt actuator 46, the wheel frame actuator(s) 48, and the rolling basket cylinder(s) 50, and so forth. Moreover, the processor 60 may include multiple microprocessors, one or more “general-purpose” microprocessors, one or more special-purpose microprocessors, and/or one or more application specific integrated circuits (ASICs), or some combination thereof. For example, the processor 60 may include one or more reduced instruction set (RISC) processors.

The memory device 64 may include a volatile memory, such as random access memory (RAM), and/or a nonvolatile memory, such as read-only memory (ROM). The memory device 64 may store a variety of information and may be used for various purposes. For example, the memory device 64 may store processor-executable instructions (e.g., firmware or software) for the processor 62 to execute, such as instructions for controlling the tilt actuator 46, the wheel frame actuator(s) 48, and the rolling basket cylinder(s) 50, and so forth. The storage device(s) (e.g., nonvolatile storage) may include ROM, flash memory, a hard drive, or any other suitable optical, magnetic, or solid-state storage medium, or a combination thereof. The storage device(s) may store data, instructions (e.g., software or firmware for controlling the tilt actuator 46, the wheel frame actuator(s) 48, and the rolling basket cylinder(s) 50, etc.), and any other suitable data.

In the illustrated embodiment, the control system 58 includes a user interface 66 communicatively coupled to the controller 60. The user interface 66 is configured to receive input from an operator and to provide information to the operator. The user interface 66 may include any suitable input device(s) for receiving input, such as a keyboard, a mouse, button(s), switch(es), knob(s), other suitable input device(s), or a combination thereof. In addition, the user interface 66 may include any suitable output device(s) for presenting information to the operator, such as speaker(s), indicator light(s), other suitable output device(s), or a combination thereof. In the illustrated embodiment, the user interface 66 includes a display 68 configured to present visual information to the operator. In certain embodiments, the display 68 may include a touchscreen interface configured to receive input from the operator.

In the illustrated embodiment, the control system 58 includes a pressure sensor 70 communicatively coupled to the controller 60. The pressure sensor 70 is configured to output a pressure sensor signal indicative of fluid pressure within the rolling basket cylinder 50. In the illustrated embodiment, the body of the rolling basket cylinder 50 is pivotally coupled to the main frame 12, and the rod of the rolling basket cylinder 50 is pivotally coupled to the mount 52. With the fluid flow to and from the rolling basket cylinder 50 blocked (e.g., such that the extension of the rolling basket cylinder 50 is fixed/constant), the contact force between the rolling basket 44 and the soil (e.g., downforce) may drive the rolling basket frame 42 to rotate with respect to the undeflected position. As a result, the resilient elements may establish a torque between the rolling basket frame 42 and the mount 52, thereby urging the mount 52 to rotate. However, rotation of the mount 52 is blocked by the rolling basket cylinder 50, thereby establishing fluid pressure within the cap end of the rolling basket cylinder 50. Accordingly, in the illustrated embodiment, the pressure sensor 70 is configured to output the pressure sensor signal indicative of fluid pressure within the cap end of the rolling basket cylinder 50. The pressure within the cap end of the rolling basket cylinder 50 is based on the torque applied by the resilient elements. In certain embodiments, the body of the rolling basket cylinder may be pivotally coupled to the mount, and the rod of the rolling basket cylinder may be pivotally coupled to the main frame. In such embodiments, the pressure sensor may be configured to output the pressure sensor signal indicative of fluid pressure within the rod end of the rolling basket cylinder.

Furthermore, in the illustrated embodiment, the control system 58 includes an angle sensor 72 communicatively coupled to the controller 60. The angle sensor 72 is configured to output an angle sensor signal indicative of an angle of the rolling basket frame 42 relative to the main frame 12. As previously discussed, the angular offset of the rolling basket frame 42 with respect to the undeflected position (e.g., with respect to the undeflected angle of the rolling basket frame 42 relative to the mount 52) is based on the angle of the rolling basket frame 42 relative to the main frame 12 and the extension of the rolling basket cylinder 50. In addition, the torque applied by the resilient elements to the rolling basket frame 42 is based on the angular offset of the rolling basket frame 42 with respect to the undeflected position. Accordingly, the angle of the rolling basket frame 42 relative to the main frame 12 is indicative of the torque applied by the resilient elements. The angle sensor 72 may include any suitable type(s) of sensor(s) configured to monitor the angle of the rolling basket frame 42 relative to the main frame 12 (e.g., rotary potentiometer(s), linear potentiometer(s), linear variable differential transformer(s) (LVDT), infrared sensor(s), etc.).

In certain embodiments, the controller 60 is configured to receive the pressure sensor signal from the pressure sensor 70. In such embodiments, the controller 60 is configured to control the tilt force applied by the tilt actuator 46 to the main frame 12 to maintain the fluid pressure within a threshold fluid pressure range of a target fluid pressure. Maintaining the fluid pressure within the threshold fluid pressure range of the target fluid pressure may substantially maintain the torque applied by the resilient elements to the rolling basket frame 42, thereby substantially maintaining the downforce applied by the rolling basket 44 to the soil. As a result, the penetration depth of the disc blades 36 (e.g., at least the rear row 40 of disc blades 36) may be substantially maintained as the tillage implement 10 is towed along the field in the direction of travel 22 (e.g., as the tillage implement 10 encounters bumpy terrain). Accordingly, the disc blades 36 of the tillage implement 10 may break up the top layer of the soil at a consistent depth, thereby enhancing the effectiveness of tillage operations. For example, while the tillage implement 10 is operating within a region of denser soil, the controller may control the tilt actuator 46 to increase the tilt force applied to the main frame 12 to maintain the fluid pressure within the threshold fluid pressure range of the target fluid pressure, thereby increasing the longitudinal rigidity of the tillage implement 10. In addition, while the tillage implement 10 is operating within a region of less dense soil, the controller may control the tilt actuator 46 to decrease the tilt force applied to the main frame 12 to maintain the fluid pressure within the threshold fluid pressure range of the target fluid pressure, thereby reducing the longitudinal rigidity of the tillage implement 10.

Furthermore, in certain embodiments, the controller 60 is configured to receive the angle sensor signal from the angle sensor 72. In such embodiments, the controller 60 is configured to control the tilt force applied by the tilt actuator 46 to the main frame to maintain the angle of the rolling basket frame 42 within a threshold angle range of a target angle. Maintaining the angle of the rolling basket frame 42 within the threshold angle range of the target angle may substantially maintain the torque applied by the resilient elements to the rolling basket frame 42, thereby substantially maintaining the downforce applied by the rolling basket 44 to the soil. As a result, the penetration depth of the disc blades 36 (e.g., at least the rear row 40 of disc blades 36) may be substantially maintained as the tillage implement 10 is towed along the field in the direction of travel 22 (e.g., as the tillage implement 10 encounters bumpy terrain). Accordingly, the disc blades 36 of the tillage implement 10 may break up the top layer of the soil at a consistent depth, thereby enhancing the effectiveness of tillage operations. For example, while the tillage implement 10 is operating within a region of denser soil, the controller may control the tilt actuator 46 to increase the tilt force applied to the main frame 12 to maintain the angle of the rolling basket frame 42 within the threshold angle range of the target angle, thereby increasing the longitudinal rigidity of the tillage implement 10. In addition, while the tillage implement 10 is operating within a region of less dense soil, the controller may control the tilt actuator 46 to decrease the tilt force applied to the main frame 12 to maintain the angle of the rolling basket frame 42 within the threshold angle range of the target angle, thereby reducing the longitudinal rigidity of the tillage implement 10.

While controlling the tilt force based on the fluid pressure within the rolling basket cylinder and controlling the tilt force based on the angle of the rolling basket frame are disclosed above, in certain embodiments, the controller may control the tilt force based on the fluid pressure within the rolling basket cylinder and the angle of the rolling basket frame. For example, the controller may control the tilt force applied by the tilt actuator to the main frame to maintain the fluid pressure within the threshold fluid pressure range of the target fluid pressure and to maintain the angle of the rolling basket frame within the threshold angle range of the target angle. In certain embodiments, if the controller is unable to maintain the fluid pressure within the threshold fluid pressure range of the target fluid pressure and to maintain the angle of the rolling basket frame within the threshold angle range of the target angle, the controller may only maintain the fluid pressure within the threshold fluid pressure range of the target fluid pressure (e.g., fluid pressure control may be prioritized over rolling basket frame angle control).

In certain embodiments, the target fluid pressure within the rolling basket cylinder 50 may be input into the user interface 66 (e.g., to establish a desired contact force between the rolling basket 44 and the soil) and/or determined by the controller 60 (e.g., based on the operation speed of the tillage implement, soil conditions, soil composition, seed type of a subsequent planting/seeding operation, etc.). Furthermore, the threshold fluid pressure range may be input into the user interface 66 and/or determined by the controller 60 (e.g., based on the operation speed of the tillage implement, soil conditions, soil composition, seed type of a subsequent planting/seeding operation, etc.).

In certain embodiments, the controller 60 is configured to determine the target angle of the rolling basket frame 42 relative to the main frame 12 based on the target fluid pressure within the rolling basket cylinder 50 and an angle/fluid pressure calibration. The angle/fluid pressure calibration may be determined by placing the tillage implement 10 on a hard flat surface (e.g., concrete pad, etc.) prior to tillage operations. While the rolling basket 44 is engaged with the hard flat surface, the controller 60 may incrementally increase the fluid pressure within the rolling basket cylinder 50. At each increment, the controller 60 may monitor the angle of the rolling basket frame 42 relative to the main frame 12 via feedback from the angle sensor 72. The controller 60 may utilize each fluid pressure (e.g., monitored via feedback from the pressure sensor 70) and each corresponding angle to establish the angle/fluid pressure calibration. The angle/fluid pressure calibration may include a table of angles/fluid pressures, an empirical equation, a curve fit equation (e.g., quadradic equation, cubic spline, etc.), another suitable angle/fluid pressure relationship, or a combination thereof. The threshold angle range may be input into the user interface 66 and/or determined by the controller 60 (e.g., based on the operation speed of the tillage implement, soil conditions, soil composition, seed type of a subsequent planting/seeding operation, etc.).

As previously discussed, the controller 60 is configured to control the tilt force applied by the tilt actuator 46 to the main frame 12 to maintain the fluid pressure within the threshold fluid pressure range of the target fluid pressure and/or to maintain the angle of the rolling basket frame 42 within the threshold angle range of the target angle. In certain embodiments, the controller 60 may control the tilt actuator 46 to apply a downward force on the main frame 12, thereby causing the rolling basket 44 to apply a downforce to the soil greater then the downforce caused by the weight of the main frame and the components coupled to the main frame. Furthermore, in certain embodiments, the controller 60 may control the tilt actuator 46 to apply an upward force on the main frame 12, thereby causing the rolling basket 44 to apply a downforce to the soil less than the downforce caused by the weight of the main frame and the components coupled to the main frame.

In the illustrated embodiment, the tilt actuator 46 includes a hydraulic cylinder. Furthermore, in the illustrated embodiment, the body of the hydraulic cylinder is pivotally coupled to the hitch frame 16, and the rod of the hydraulic cylinder is pivotally coupled to the main frame 12. The controller is configured to control the fluid pressure within the cap end and/or the rod end of the hydraulic cylinder to control the tilt force applied by the tilt actuator to the main frame. In certain embodiments, the controller may be configured to control the fluid pressure within the cap end and/or the rod end of the hydraulic cylinder to control the stiffness of the tilt actuator (e.g., to adjust the dynamics/kinematics of the tillage implement as the tillage implement traverses a field). While the body of the hydraulic cylinder is pivotally coupled to the hitch frame 16 and the rod of the hydraulic cylinder is pivotally coupled to the main frame 12 in the illustrated embodiment, in certain embodiments, the body of the tilt cylinder may be pivotally coupled to the main frame, and the rod of the tilt cylinder may be pivotally coupled to the hitch frame. Regardless of the mounting direction of the hydraulic cylinder, the controller is configured to control the fluid pressure (e.g., tilt fluid pressure) at each end of the hydraulic cylinder to control the tilt force and the stiffness of the tilt actuator. While the tilt actuator 46 includes a hydraulic cylinder in the illustrated embodiment, in other embodiments, the tilt actuator may include a pneumatic cylinder, an electric linear actuator, etc.

For each cylinder of the tillage implement (e.g., including the rolling basket cylinder(s) and tilt cylinder in embodiments in which the tilt actuator includes a cylinder), the controller is communicatively coupled to the cylinder via a valve assembly of the control system. The valve assembly may include any suitable number of valves and any suitable type(s) of valve(s). Furthermore, the control system may include any suitable number of valve assemblies (e.g., a single valve assembly fluidly coupled to each cylinder, one valve assembly for each cylinder, etc.). The controller is configured to output control signal(s) to each valve assembly, and each valve assembly is configured to adjust fluid flow (e.g., fluid pressure, fluid flow rate, etc.) to the respective cylinder(s) fluidly coupled to the valve assembly. Accordingly, the controller is configured to control the cylinders via the valve assembly/assemblies.

In certain embodiments, the controller 60 is configured to limit the tilt force applied by the tilt actuator 46 to a maximum tilt force. For example, as the controller 60 is controlling the tilt force applied by the tilt actuator 46, the controller 60 may not control the tilt actuator 46 to apply a tilt force greater than the maximum tilt force, thereby limiting the stress on components of the tillage implement. The maximum tilt force may be stored within the controller 60 (e.g., input by the operator into the user interface 66, established by the manufacturer, etc.).

As previously discussed, in certain embodiments, the rolling basket frame 42 has multiple sections. In such embodiments, at least one rolling basket cylinder 50 may be coupled to each section of the rolling basket frame 42, and the rolling basket cylinders may be fluidly coupled to one another (e.g., in a parallel flow arrangement). Accordingly, the control system 58 may include a single pressure sensor 70 (e.g., fluidly coupled to one rolling basket cylinder 50 and/or to one conduit/line fluidly coupled to the rolling basket cylinder(s) 50). Additionally or alternatively, the control system 58 may include a single angle sensor 72 configured to output the angle sensor signal indicative of the angle of one rolling basket frame 42. However, in other embodiments, the control system may include multiple pressure sensors and/or multiple angle sensors (e.g., in embodiments in which each rolling basket cylinder is independently controllable). In such embodiments, the controller may receive multiple pressure sensor signals and/or multiple angle sensor signals, and the controller may control the tilt force based on a statistical analysis of the fluid pressures within the rolling basket cylinders and/or the angles of the rolling basket frames (e.g., mean, minimum, maximum, median, etc.).

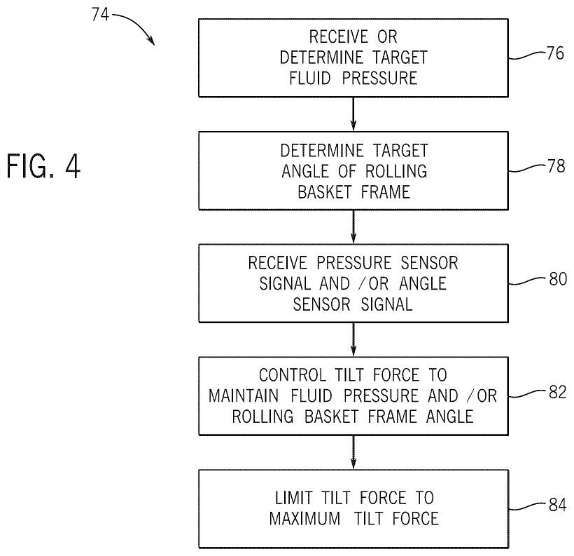

FIG. 4 is a flow diagram of an embodiment of a method for controlling a tilt actuator of a tillage implement. The method 74 may be performed by the controller disclosed above with reference to FIG. 3 or any other suitable controller(s). Furthermore, the steps of the method 74 may be performed in the order disclosed herein or in any other suitable order. For example, certain steps of the method may be performed concurrently. In addition, in certain embodiments, at least one of the steps of the method 74 may be omitted.

In certain embodiments, the method 74 includes receiving or determining the target fluid pressure within the rolling basket cylinder, as represented by block 76. As previously discussed, the target fluid pressure within the rolling basket cylinder may be received from the user interface and/or determined (e.g., based on the operation speed of the tillage implement, soil conditions, soil composition, seed type of a subsequent planting/seeding operation, etc.). Furthermore, in certain embodiments, the method 74 includes determining the target angle of the rolling basket frame relative to the main frame based on the target fluid pressure within the rolling basket cylinder and an angle/fluid pressure calibration, as represented by block 78. As previously discussed, the angle/fluid pressure calibration may be determined by placing the tillage implement on a hard flat surface (e.g., concrete pad, etc.) prior to tillage operations. While the rolling basket is engaged with the hard flat surface, the fluid pressure within the rolling basket cylinder may be incrementally increased. At each increment, the angle of the rolling basket frame relative to the main frame may be monitored. Each fluid pressure and each corresponding angle may be utilized to establish the angle/fluid pressure calibration.

In the illustrated embodiment, the method 74 includes receiving the pressure sensor signal indicative of the fluid pressure within the rolling basket cylinder and/or the angle sensor signal indicative of the angle of the rolling basket frame relative to the main frame, as represented by block 80. As previously discussed, the pressure sensor signal may be received from the pressure sensor. In addition, the angle sensor signal may be received from the angle sensor.

In addition, the method 74 includes controlling the tilt force applied by the tilt actuator to the main frame to maintain the fluid pressure within the threshold fluid pressure range of the target fluid pressure and/or to maintain the angle of the rolling basket frame within the threshold angle range of the target angle, as represented by block 82. Maintaining the fluid pressure within the threshold fluid pressure range of the target fluid pressure and/or maintaining the angle of the rolling basket frame within the threshold angle range of the target angle may substantially maintain the penetration depth of the disc blades (e.g., at least the rear row of disc blades) as the tillage implement is towed along the field in the direction of travel (e.g., as the tillage implement 10 encounters bumpy terrain). As a result, the disc blades of the tillage implement may break up the top layer of the soil at a consistent depth, thereby enhancing the effectiveness of tillage operations. In embodiments in which the tilt actuator includes a hydraulic cylinder, the tilt fluid pressure at each end of the hydraulic cylinder may be controlled to control the tilt force and the stiffness of the tilt actuator, as discussed above with reference to FIG. 3.

As represented by block 84, the method 74 includes limiting the tilt force applied by the tilt actuator to a maximum tilt force. For example, as the tilt force applied by the tilt actuator is controlled, the tilt actuator may not be controlled to apply a tilt force greater than the maximum tilt force. As a result, the stress on components of the tillage implement may be limited.

While the tillage implement includes a rolling basket in the embodiments disclosed herein, in certain embodiments, the tillage implement may include other suitable type(s) of gauge device(s) (e.g., alone or in combination with the rolling basket), such as gauge wheel(s), skid(s), etc. In such embodiments, the gauge device(s) are coupled to gauge device frame(s) that are movably (e.g., pivotally) coupled to the main frame, and gauge device cylinder(s) are coupled to the main frame and to the gauge device frame(s). Furthermore, while the tillage implement includes a tilt actuator coupled to the main frame and to the hitch frame in the illustrated embodiment, in other embodiments, the tillage implement may include another suitable frame force actuator configured to apply a frame force to the main frame, thereby urging the main frame toward the surface of the field. For example, in certain embodiments, the frame force actuator may be coupled to the main frame and to a chassis of a self-propelled vehicle (e.g., in which the main frame is pivotally coupled to the chassis). In certain embodiments, the controller may receive the pressure sensor signal indicative of the fluid pressure within the gauge device cylinder and/or the angle sensor signal indicative of the angle of the gauge device frame relative to the main frame. The controller may also control the frame force applied by the frame force actuator to the main frame to maintain the fluid pressure within the threshold fluid pressure range of the target fluid pressure and/or to maintain the angle of the gauge device frame within the threshold angle range of the target angle.

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112 (f). However, for any claims containing elements designated in any other manner, it is intended that such elements are not to be interpreted under 35 U.S.C. 112 (f).

1. A control system for an agricultural tillage implement, comprising:
a controller comprising a memory and a processor, wherein the controller is configured to:
receive a pressure sensor signal indicative of a fluid pressure within a rolling basket cylinder, an angle sensor signal indicative of an angle of a rolling basket frame relative to a main frame of the agricultural tillage implement, or a combination thereof, wherein the rolling basket cylinder is configured to couple to the main frame and to the rolling basket frame; and
control a tilt force applied by a tilt actuator to the main frame to maintain the fluid pressure within a threshold fluid pressure range of a target fluid pressure, to maintain the angle of the rolling basket frame within a threshold angle range of a target angle, or a combination thereof, wherein the tilt actuator is configured to couple to a hitch assembly of the agricultural tillage implement and to apply the tilt force to the main frame.

2. The control system of claim 1, comprising a pressure sensor communicatively coupled to the controller, wherein the pressure sensor is configured to output the pressure sensor signal indicative of the fluid pressure within the rolling basket cylinder.

3. The control system of claim 1, comprising an angle sensor communicatively coupled to the controller, wherein the angle sensor is configured to output the angle sensor signal indicative of the angle of the rolling basket frame relative to the main frame.

4. The control system of claim 1, wherein the tilt actuator comprises a hydraulic cylinder, and the controller is configured to control a tilt fluid pressure at each end of the hydraulic cylinder to control the tilt force and a stiffness of the tilt actuator.

5. The control system of claim 1, wherein the controller is configured to determine the target angle of the rolling basket frame relative to the main frame based on the target fluid pressure within the rolling basket cylinder and an angle/fluid pressure calibration.

6. The control system of claim 1, comprising a user interface communicatively coupled to the controller, wherein the user interface is configured to receive an input indicative of the target fluid pressure.

7. The control system of claim 1, wherein the controller is configured to limit the tilt force applied by the tilt actuator to a maximum tilt force.

8. A tillage implement, comprising:
a main frame configured to support a plurality of disc blades;
a rolling basket frame pivotally coupled to the main frame, wherein the rolling basket frame is configured to support a rolling basket;
a hitch assembly pivotally coupled to the main frame;
a wheel frame pivotally coupled to the hitch assembly, wherein the wheel frame is configured to support a plurality of wheels;
a rolling basket cylinder coupled to the main frame and to the rolling basket frame;
a tilt actuator coupled to the hitch assembly and to the main frame, wherein the tilt actuator is configured to apply a tilt force to the main frame; and
a control system comprising a controller having a memory and a processor, wherein the controller is communicatively coupled to the tilt actuator, and the controller is configured to:
receive a pressure sensor signal indicative of a fluid pressure within the rolling basket cylinder, an angle sensor signal indicative of an angle of the rolling basket frame relative to the main frame, or a combination thereof; and
control the tilt force applied by the tilt actuator to the main frame to maintain the fluid pressure within a threshold fluid pressure range of a target fluid pressure, to maintain the angle of the rolling basket frame within a threshold angle range of a target angle, or a combination thereof.

9. The tillage implement of claim 8, wherein the control system comprises a pressure sensor communicatively coupled to the controller, and the pressure sensor is configured to output the pressure sensor signal indicative of the fluid pressure within the rolling basket cylinder.

10. The tillage implement of claim 8, wherein the control system comprises an angle sensor communicatively coupled to the controller, and the angle sensor is configure to output the angle sensor signal indicative of the angle of the rolling basket frame relative to the main frame.

11. The tillage implement of claim 8, wherein the tilt actuator comprises a hydraulic cylinder, and the controller is configured to control a tilt fluid pressure at each end of the hydraulic cylinder to control the tilt force and a stiffness of the tilt actuator.

12. The tillage implement of claim 8, wherein the controller is configured to determine the target angle of the rolling basket frame relative to the main frame based on the target fluid pressure within the rolling basket cylinder and an angle/fluid pressure calibration.

13. The tillage implement of claim 8, wherein the control system comprises a user interface communicatively coupled to the controller, wherein the user interface is configured to receive an input indicative of the target fluid pressure.

14. The tillage implement of claim 8, wherein the controller is configured to limit the tilt force applied by the tilt actuator to a maximum tilt force.

15. A method, comprising:
receiving, via a controller comprising a memory and a processor, a pressure sensor signal indicative of a fluid pressure within a rolling basket cylinder, an angle sensor signal indicative of an angle of a rolling basket frame relative to a main frame of an agricultural tillage implement, or a combination thereof, wherein the rolling basket cylinder is configured to couple to the main frame and to the rolling basket frame; and
controlling, via the controller, a tilt force applied by a tilt actuator to the main frame to maintain the fluid pressure within a threshold fluid pressure range of a target fluid pressure, to maintain the angle of the rolling basket frame within a threshold angle range of a target angle, or a combination thereof, wherein the tilt actuator is configured to coupled to a hitch assembly of the agricultural tillage implement and to apply the tilt force to the main frame.

16. The method of claim 15, comprising determining, via the controller, the target angle of the rolling basket frame relative to the main frame based on the target fluid pressure within the rolling basket cylinder and an angle/fluid pressure calibration.

17. The method of claim 15, comprising receiving the target fluid pressure from a user interface.

18. The method of claim 15, comprising limiting, via the controller, the tilt force applied by the tilt actuator to a maximum tilt force.

19. The method of claim 15, wherein receiving the pressure sensor signal comprises receiving the pressure sensor signal from a pressure sensor configured to output the pressure sensor signal indicative of the fluid pressure within the rolling basket cylinder.

20. The method of claim 15, wherein receiving the angle sensor signal comprises receiving the angle sensor signal from an angle sensor configured to output the angle sensor signal indicative of the angle of the rolling basket frame relative to the main frame.
